(19) United States
(12) Patent Application Publication
(10) Pub. No.: US 2008/0122769 A1
(43) Pub. Date: May 29, 2008

(54) LIQUID CRYSTAL DISPLAY DEVICE

(75) Inventor: Jiro TAKAKI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/873,906

(22) Filed: Oct. 17, 2007

(30) Foreign Application Priority Data
Nov. 29, 2006 (JP) 2006-321099
Feb. 5, 2007 (JP) 2007-025030

(51) Int. Cl. G09G 3/36

(52) U.S. Cl. 345/87

(57) ABSTRACT

A liquid crystal display device according to the present invention includes a data storage circuit that stores frame data of the previous image of a liquid crystal panel, and an overdrive calculation circuit that compares the frame data stored in the data storage circuit and input data of the next image to be displayed on the liquid crystal panel and performs overdrive output to the liquid crystal panel. The overdrive output is performed over a plurality of frame periods.

### BACKGROUND OF THE INVENTION

1. Field of the Invention

The present invention relates to liquid crystal display devices and, more specifically, to a drive circuit of a liquid crystal display device.

2. Description of the Background Art

When moving images are displayed on a liquid crystal display device, a trail-leaving phenomenon or an afterimage sometimes occurs. To address this problem, a conventional method is known of accelerating a response of liquid crystal by using a function called overdrive. The overdrive function attains target gradation by, when the gradation of moving images being displayed on a liquid crystal panel falls short of the target gradation, temporarily increasing applied voltage to the liquid crystal panel to compensate for the shortage of applied voltage. That is, this is a function of reducing the response time of liquid crystal by temporarily increasing applied voltage to a liquid crystal panel, to eliminate an afterimage and the like on displayed moving images.

In a conventional liquid crystal display device, applying the compensated voltage in the previous frame without change to the frame of moving images currently being displayed causes the gradation to exceed the target gradation. For this reason, the overdrive function is terminated upon change in frame of moving images being displayed. The overdrive function is thus performed during one frame.

The speed of response of liquid crystal to applied voltage depends on the temperature, and becomes slower as the temperature decreases.

To improve deterioration of such display characteristic of moving images with variation in temperature, a conventional liquid crystal display device changes the degree of performing overdrive depending on the temperature, to display optimum moving images in every temperature area. The overdrive function in a conventional liquid crystal display device is disclosed in Japanese Patent Application Laid-Open Nos. 2004-133159, 2006-195231, 2006-243325, 2003-143556, and 2004-302023.

Recently, however, liquid crystal display devices have been used in various ways such as outdoors, with increasing frequency of being used in a low-temperature environment beyond conventional expectation. This has caused a problem for a conventional liquid crystal display device that the target gradation cannot be attained during one frame by performing overdrive with maximum voltage applied to a liquid crystal panel, thus failing to obtain the sufficient effect of overdrive.

### SUMMARY OF THE INVENTION

It is an object of the present invention to improve moving-image display at a low temperature, and provide a liquid crystal display device capable of displaying optimum moving images in every temperature area.

In an aspect of the invention, a liquid crystal display device includes: a data storage circuit that stores frame data of the previous image of a liquid crystal panel; and an overdrive calculation circuit that compares the frame data stored in the data storage circuit and input data of the next image to be displayed on the liquid crystal panel and performs overdrive output to the liquid crystal panel, wherein the overdrive output is performed over a plurality of frame periods.

As the overdrive output is performed over a plurality of frame periods, optimum moving images can be displayed in every temperature range.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit block diagram of the whole of a liquid crystal display device according to a first preferred embodiment of the present invention;

FIG. 2 is a block diagram of a drive circuit of the liquid crystal display device according to the first preferred embodiment of the present invention, the drive circuit performing overdrive over a plurality of frames;

FIG. 3 is a timing chart (ODD frame and EVEN frame) of a control signal in conventional overdrive;

FIG. 4 is a timing chart (n frame and n+1 frame) of a control signal according to the first preferred embodiment of the present invention;

FIG. 5 is a timing chart (n+2 frame and n+3 frame) of the control signal according to the first preferred embodiment of the present invention;

FIG. 6 is a timing chart (n frame and n+1 frame) of a control signal according to a second preferred embodiment of the present invention;

FIG. 7 is a timing chart (n+2 frame and n+3 frame) of the control signal according to the second preferred embodiment of the present invention;

FIG. 8 is a timing chart (n frame and n+1 frame) of a control signal according to a fourth preferred embodiment of the present invention;

FIG. 9 is a timing chart (n+2 frame and n+3 frame) of the control signal according to the fourth preferred embodiment of the present invention;

FIG. 10 is a timing chart (n frame and n+1 frame) of a control signal according to a fifth preferred embodiment of the present invention;

FIG. 11 is a timing chart (n+2 frame and n+3 frame) of the control signal according to the fifth preferred embodiment of the present invention; and

FIG. 12 is a timing chart (ODD frame and EVEN frame) of a control signal according to a sixth preferred embodiment of the present invention.

### DESCRIPTION OF THE PREFERRED EMBODIMENTS

Preferred embodiments of the present invention will be described with reference to the attached drawings.

### First Preferred Embodiment

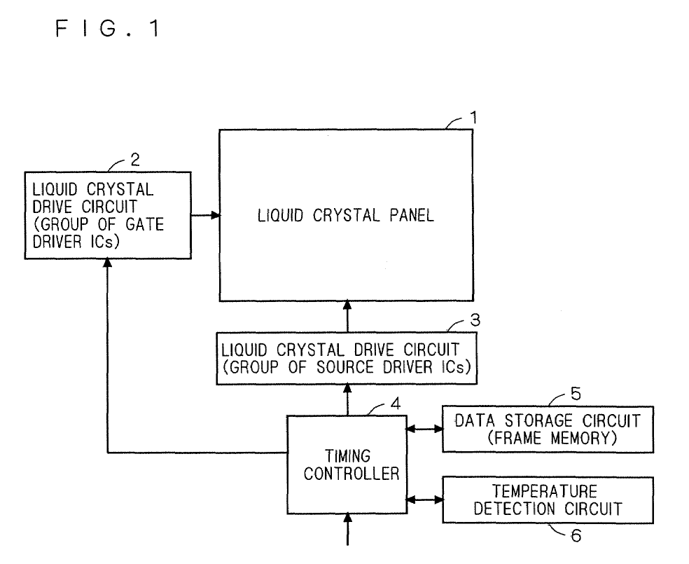

FIG. 1 is a circuit block diagram of the whole of a liquid crystal display device according to a first preferred embodiment of the present invention. As shown, a liquid crystal drive circuit (group of gate driver ICs) 2 is connected to a gate electrode disposed in a direction parallel to the longitudinal direction of a liquid crystal panel 1, and a liquid crystal drive circuit (group of source driver ICs) 3 is connected to a source electrode disposed in a direction perpendicular to the longitudinal direction. A timing controller 4 is connected to the liquid crystal drive circuit (group of gate driver ICs) 2 and the liquid crystal drive circuit (group of source driver ICs) 3, and controls the drive circuits 2 and 3 based on signal information from a data storage circuit (frame memory) 5 and a temperature detection circuit 6.

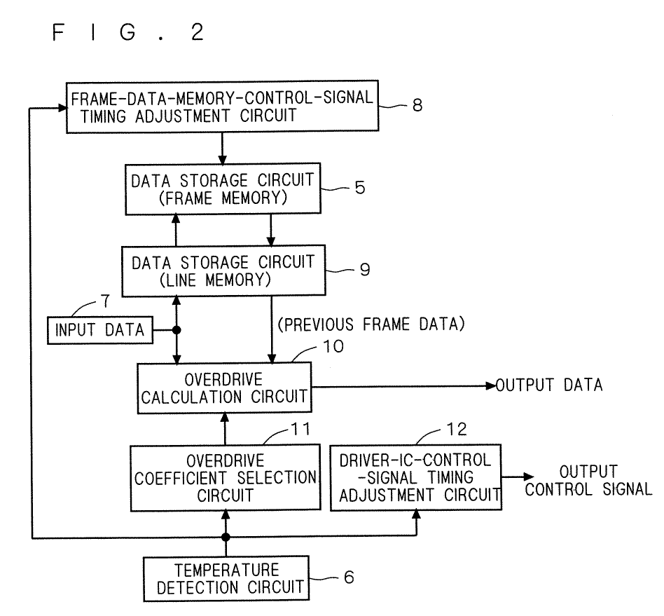

FIG. 2 is a block diagram of a drive circuit of the liquid crystal display device according to the first preferred embodiment. The drive circuit performs overdrive over a plurality of frame periods. The temperature detection circuit 6 is disposed in the vicinity of the liquid crystal panel 1, and detects a temperature around the liquid crystal panel 1. The temperature data detected by the temperature detection circuit 6 is transmitted to a frame-data-memory-control-signal timing adjustment circuit 8, an overdrive coefficient selection circuit 11, and a driver-IC-control-signal timing adjustment circuit 12.

The frame-data-memory-control-signal timing adjustment circuit 8 transmits a frame data memory control signal to the data storage circuit (frame memory) 5 based on the temperature data from the temperature detection circuit 6, to transmit frame data of the previous image displayed on the liquid crystal panel 1 stored in the data storage circuit (frame memory) 5 successively to an overdrive calculation circuit 10 via a data storage circuit (line memory) 9. Simultaneously with this process, input data 7 of the next image to be displayed on the liquid crystal panel 1 is successively transmitted to the overdrive calculation circuit 10, while the input data 7 is successively overwritten and stored in an area that stored the frame data of the previous image in the data storage circuit (frame memory) 5.

The overdrive coefficient selection circuit 11 determines the degree of overdrive output for the liquid crystal panel 1 based on the temperature data received from the temperature detection circuit 6, and transmits the result to the overdrive calculation circuit 10. To attain target gradation, the overdrive calculation circuit 10 compares the frame data of the previous image stored in the data storage circuit (line memory) 9 and the input data 7 of the next image to be displayed on the liquid crystal panel 1 and takes the overdrive coefficient received from the overdrive coefficient selection circuit 11 into consideration, to output data to the liquid crystal drive circuit (group of source driver ICs) 3. The driver-IC-control-signal timing adjustment circuit 12 outputs an output control signal to the liquid crystal drive circuit (group of gate driver ICs) 2 and the liquid crystal drive circuit (group of source driver ICs) 3 based on the temperature data from the temperature detection circuit 6. The driver-IC-control-signal timing adjustment circuit 12 is incorporated in the timing controller 4.

When the temperature is so low that the target gradation cannot be attained during one frame period by performing overdrive based on the temperature data detected by the temperature detection circuit 6 in the first preferred embodiment, the overdrive coefficient selection circuit 11 adjusts the overdrive coefficient in a manner that attains the target gradation over two frame periods.

A method of storing data in the data storage circuit (frame memory) 5 is not to rewrite all frame data in the data storage circuit (frame memory) 5, but to store frame data of different frames in areas of the data storage circuit (frame memory) 5 that correspond to odd lines and even lines of the frame data, respectively, thereby allowing overdrive output to be performed over two frame periods as discussed later.

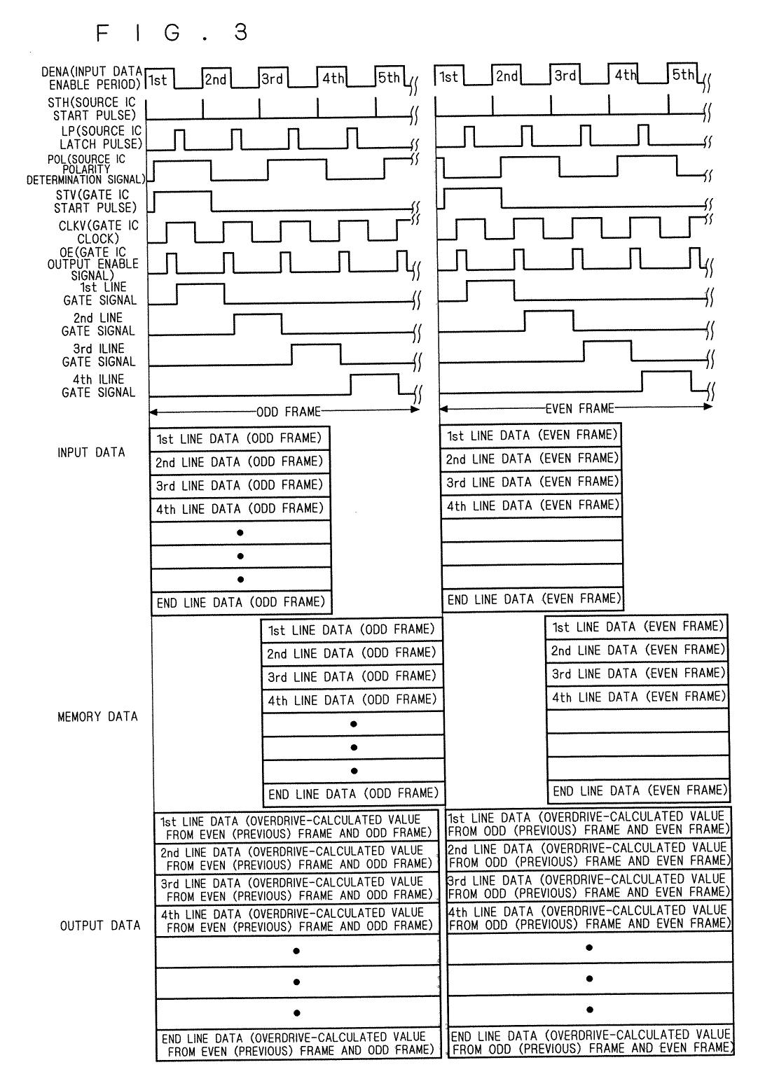

FIG. 3 is a timing chart (ODD frame and EVEN frame) of a control signal in conventional overdrive. As shown, output timing of the control signal is determined by referring to DENA (input data enable period) inputted to the timing controller 4. The signs “1st”, “2nd”, “3rd”, . . . indicated in the DENA denote a line number of one line storage area in the data storage circuit (frame memory) 5. In the liquid crystal drive circuit (group of gate driver ICs) 2, when STV (gate IC start pulse) is in a high state, the leading edge of CLKV (gate IC clock) causes the gate electrode in the 1st line to try to enter an on state. And with each of the subsequent leading edges of the CLKV, the gate electrode shifted to the next line by one tries to turn on. Whether the gate electrode becomes on or remains off at this time depends on OE (gate IC output enable signal). Meanwhile, in the liquid crystal drive circuit (group of source driver ICs) 3, LP (source IC latch pulse) is raised to become high during a period from when STH (source IC start pulse) becomes high to when the STH becomes high the next time (the period corresponds to one line of the gate electrode), to output output data to the source electrode of the liquid crystal panel 1. As indicated by POL (source IC polarity determination signal), it can be seen that the polarity of voltage applied to the liquid crystal panel 1 reverses. In FIG. 3, the polarity reverses with a change in frame or a change in line of line data. The input data 7 is stored as memory data in the data storage circuit (frame memory) 5. As the output data, an overdrive-calculated value calculated by the overdrive calculation circuit 10 from line data of the frame of the previous image stored in the data storage circuit (frame memory) 5 and the input data 7 is output to the liquid crystal panel 1 while a line gate signal is high.

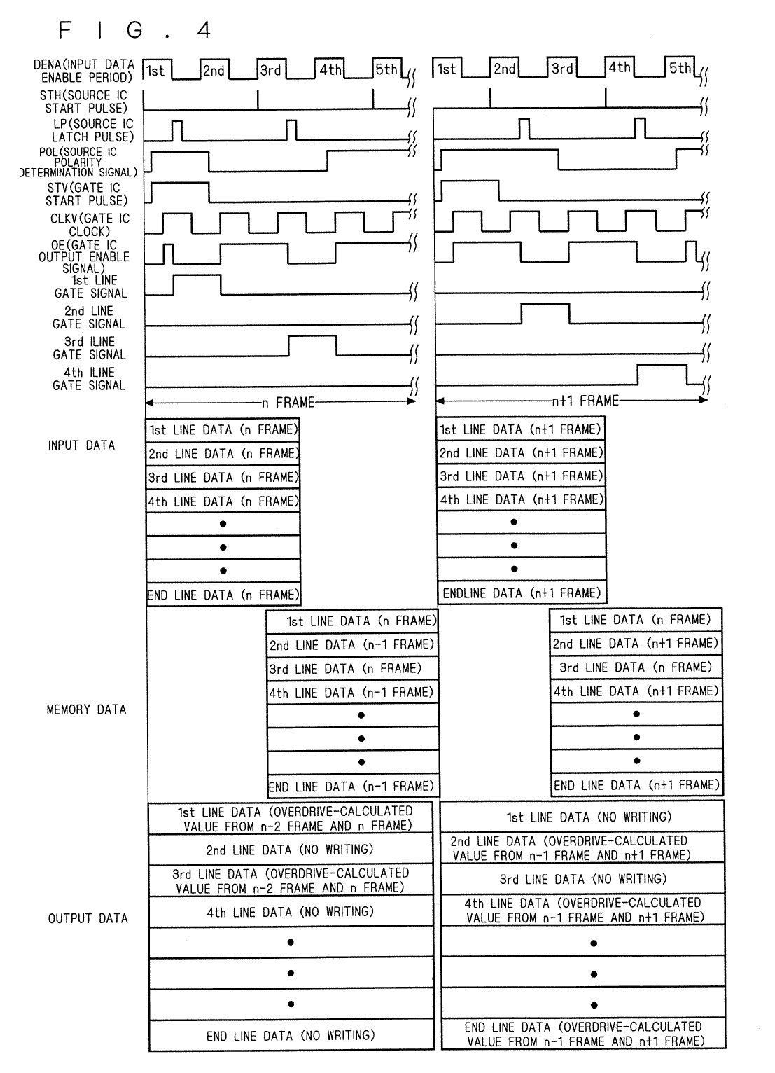

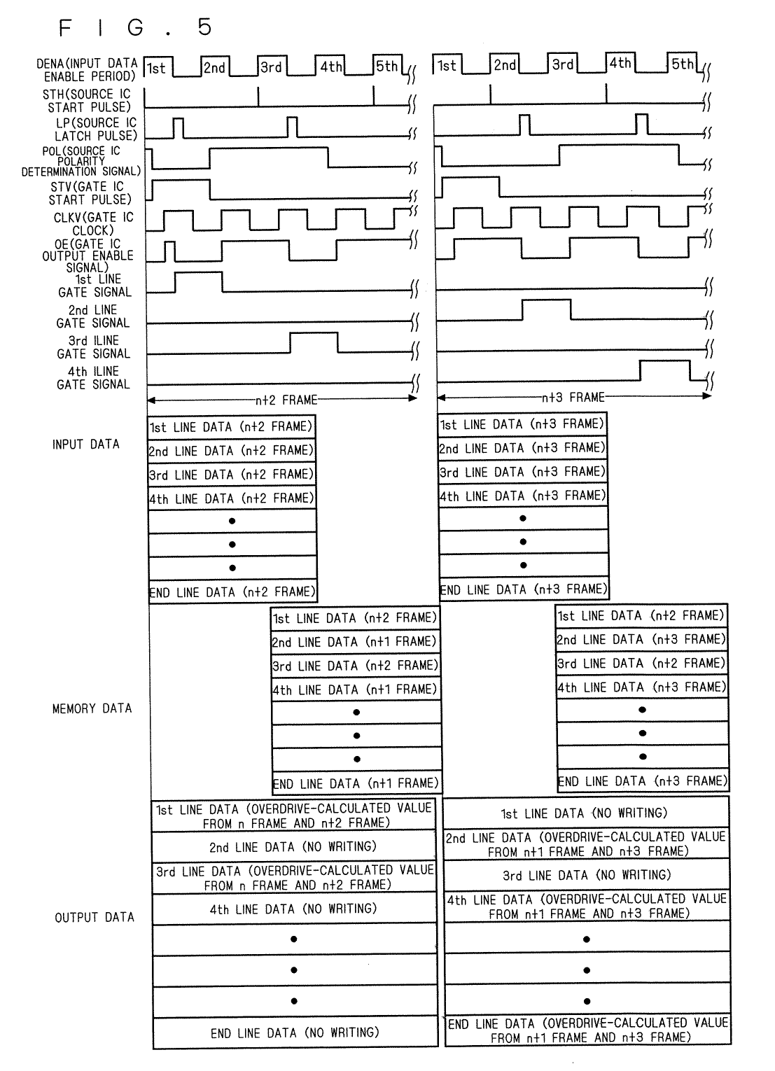

FIG. 4 is a timing chart (n frame and n+1 frame) of a control signal according to the first preferred embodiment of the present invention. FIG. 5 is a timing chart (n+2 frame and n+3 frame) of the control signal according to the first preferred embodiment. The combination of FIGS. 4 and 5 shows a timing chart of the control signal from the n frame until the n+3 frame.

One of the differences between the first preferred embodiment of the present invention shown in FIGS. 4 and 5 and the conventional method shown in FIG. 3 is how to store data in a data storage circuit. In the conventional method, all data stored in the data storage circuit (frame memory) 5 is rewritten with a change in frame. In the first preferred embodiment shown in FIG. 4, on the other hand, frame data of different frames are stored in odd lines and even lines of the data storage circuit (frame memory) 5, respectively. For example, in the memory data during the n frame shown in FIG. 4, data during the n frame (the input data 7) is stored in odd lines and data during the n−1 frame (data of the previous frame) is stored in even numbers. Thus in this case, only data in the odd lines is rewritten. And only for the odd lines whose data will be rewritten, the overdrive calculation circuit 10 calculates an overdrive-calculated value and outputs the result data to the liquid crystal panel 1. This allows overdrive to be performed over a plurality of frame periods, thereby attaining the target gradation.

In addition, the polarity of voltage applied to the liquid crystal panel 1 is changed as indicated by the POL shown in FIGS. 4 and 5 because only one side of polarity could cause problems such as image persistence. In FIG. 3, the polarity reverses with a change in frame or a change in line of line data. In FIG. 4, on the other hand, the POL controls the polarity to reverse every third line of the line data, and the line to be shifted by one with a change in frame. Namely, when the polarity of the 1st line is positive during the n frame, for example, the polarity becomes negative during the n+2 frame. Since the STH, LP and OE are so controlled as not to perform writing in pixels during the n+1 frame and n+3 frame to maintain the polarity written in the previous frame, the polarity becomes positive during the n+1 frame, and negative during the n+3 frame. Whereas the STH, LP and OE are raised to become high every other line to perform writing in pixels of the liquid crystal panel 1 in FIG. 3, the STH, LP and OE are raised to become high every third line in order to output data to odd lines or even liens in FIG. 4.

As has been described, frame data of different frames are stored in odd lines and even lines of the data storage circuit (frame memory) 5, respectively, and writing in pixels is performed every other line in the first preferred embodiment. This allows overdrive output to be performed over two frame periods to attain the target gradation, and also reduces power consumption. Further, the effects similar to those of conventional devices can be obtained without increasing memory capacity.

### Second Preferred Embodiment

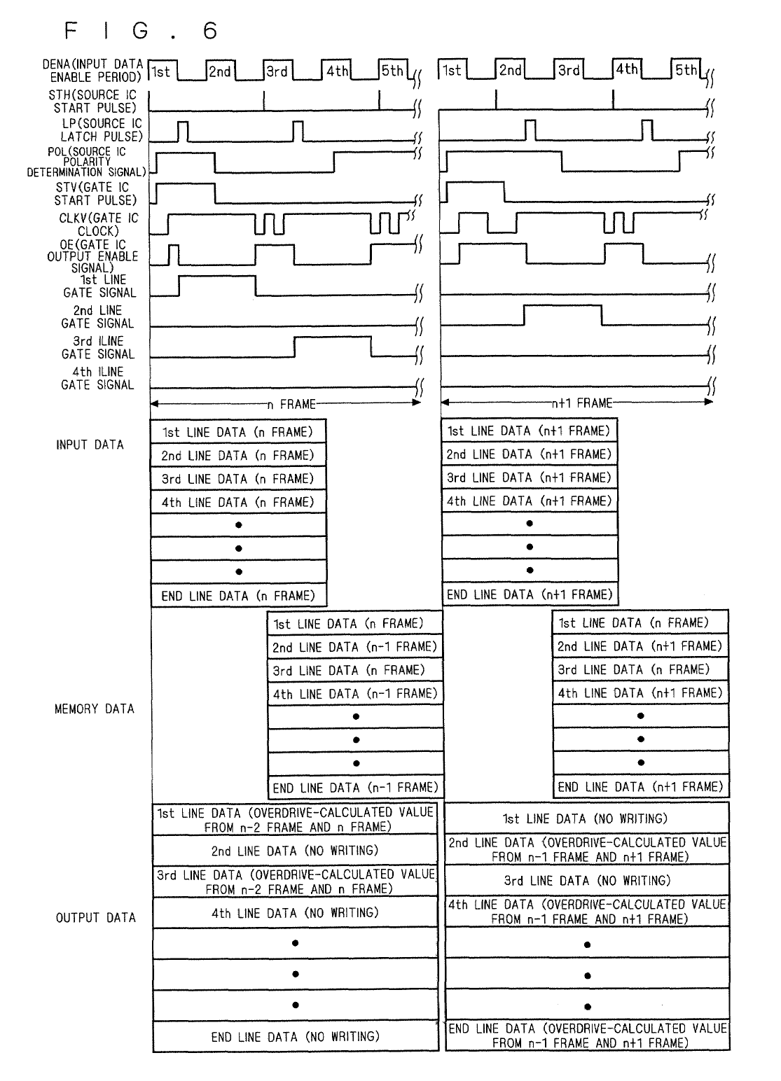

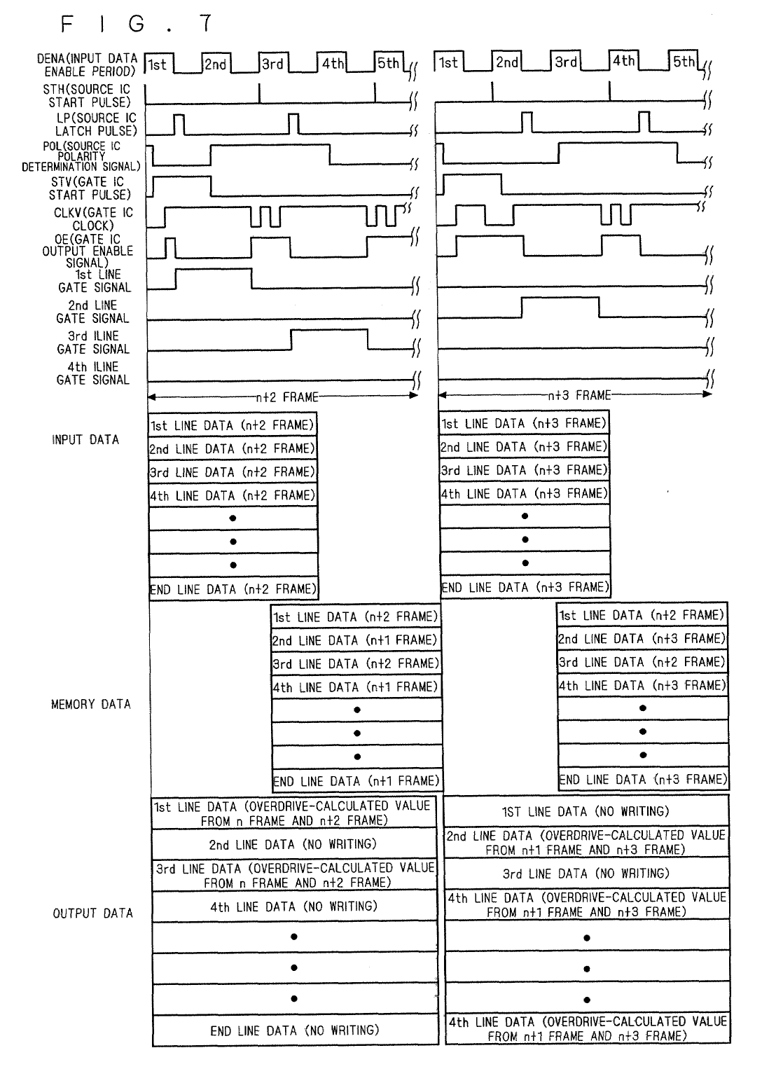

FIG. 6 is a timing chart (n frame and n+1 frame) of a control signal according to a second preferred embodiment of the present invention. FIG. 7 is a timing chart (n+2 frame and n+3 frame) of the control signal according to the second preferred embodiment. The combination of FIGS. 6 and 7 shows a timing chart of the control signal from the n frame until the n+3 frame. The respective signals outputted from the liquid crystal drive circuit (group of source driver ICs) 3 operate in the same way as indicated in FIGS. 4 and 5. A drive circuit of the liquid crystal display device is identical to that according to the first preferred embodiment.

The difference between the second preferred embodiment and the first preferred embodiment is that the duty ratio of the CLKV (gate IC clock) and OE (gate IC output enable signal) are changed. Namely, as indicated in FIG. 6, the high period of the CLKV is lengthened and the high period of the OE is shortened. By doing so, the on time of each gate line of the liquid crystal panel 1 becomes longer than in the first preferred embodiment, resulting in longer charging time to each source line. A method of storing memory data is similar to that according to the first preferred embodiment.

As has been described, frame data of different frames are stored in odd lines and even lines of the data storage circuit (frame memory) 5, respectively, and writing in pixels is performed every other line in the second preferred embodiment. This allows overdrive output to be performed over two frame periods to attain the target gradation, and also reduces power consumption. Further, the long on time of each gate line of the liquid crystal panel 1 leads to the long charging time to each source line.

### Third Preferred Embodiment

In a third preferred embodiment of the present invention, the respective signals outputted from the liquid crystal drive circuit (group of gate driver ICs) 2 operate in the same way as indicated in FIGS. 4 and 5. A drive circuit of the liquid crystal display device is identical to that according to the first preferred embodiment.

A characteristic of the third preferred embodiment is to combine the STH (source IC start pulse) and LP (source IC latch pulse) shown in the timing chart of the control signal in conventional overdrive, and the POL (source IC polarity determination signal), STV (gate IC start pulse), CLKV (gate IC clock), OE (gate IC output enable signal) and memory data control shown in the timing chart (n frame to n+3 frame) of the control signal according to the first preferred embodiment.

Adjusting output timing of a control signal with the conventional STH and LP for the liquid crystal drive circuit (group of source driver ICs) 3, and with the POL, the timing of the control signal of the liquid crystal drive circuit (group of gate driver ICs) 2 and the control of the data storage circuit (frame memory) 5 according to the first preferred embodiment in this manner yields the effects similar to those of the first preferred embodiment. However, power consumption will not be reduced due to the fact that each source line of the liquid crystal panel 1 may be in an on state while each gate line is in an off state.

### Fourth Preferred Embodiment

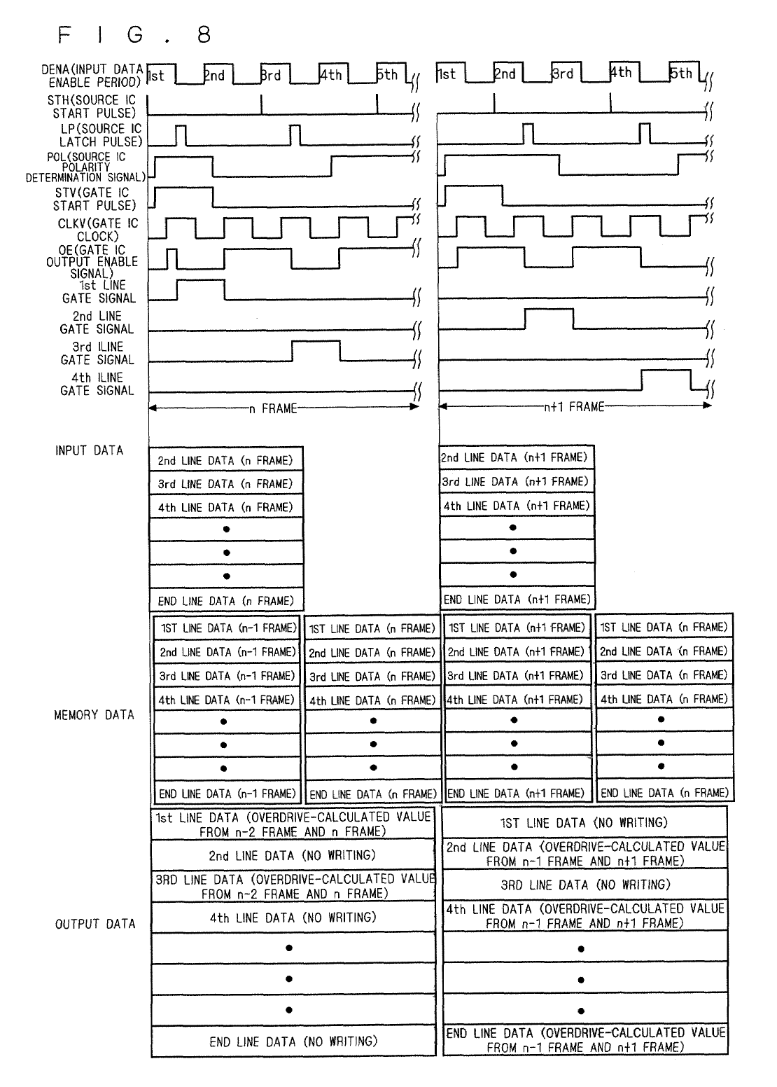

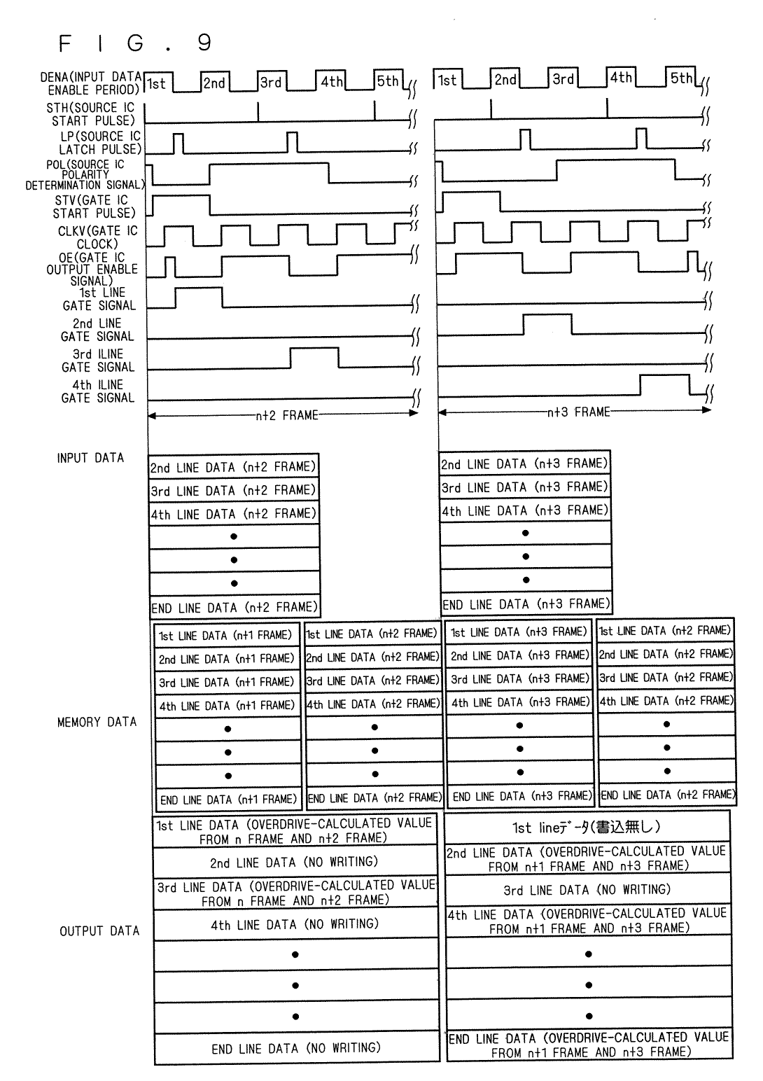

FIG. 8 is a timing chart (n frame and n+1 frame) of a control signal according to a fourth preferred embodiment of the present invention. FIG. 9 is a timing chart (n+2 frame and n+3 frame) of the control signal according to the fourth preferred embodiment. The combination of FIGS. 8 and 9 shows a timing chart of the control signal from the n frame until the n+3 frame. The respective signals outputted from the liquid crystal drive circuit (group of gate driver ICs) 2 and the liquid crystal drive circuit (group of source driver ICs) 3 operate in the same way as indicated in FIGS. 4 and 5. A drive circuit of the liquid crystal display device is identical to that according to the first preferred embodiment.

A characteristic of the fourth preferred embodiment is that a data storage circuit has capacity for two frames. Namely, frame data of different frames are stored in odd lines and even lines of the data storage circuit (frame memory) 5 having one-frame capacity, respectively, in the first preferred embodiment. Meanwhile, in the fourth preferred embodiment, all data stored in one of the one-frame capacities of the data storage circuit having two-frame capacity is rewritten, and all data stored in the other one of the one-frame capacities is rewritten with a change in frame.

As has been described, the data storage circuit has capacity for two frames, data of one frame is stored in each of the one-frame capacities of the data storage circuit having two-frame capacity, and writing in pixels is performed every other line in the fourth preferred embodiment. This allows overdrive to be performed over two frame periods, thereby attaining the target gradation.

### Fifth Preferred Embodiment

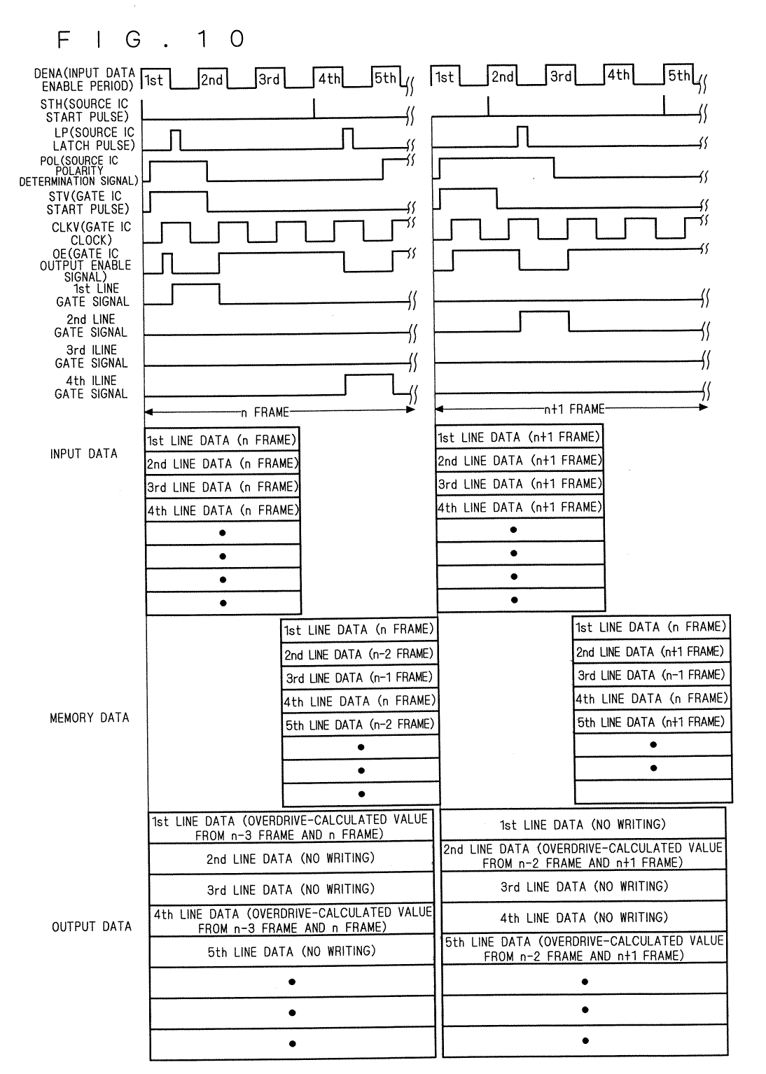

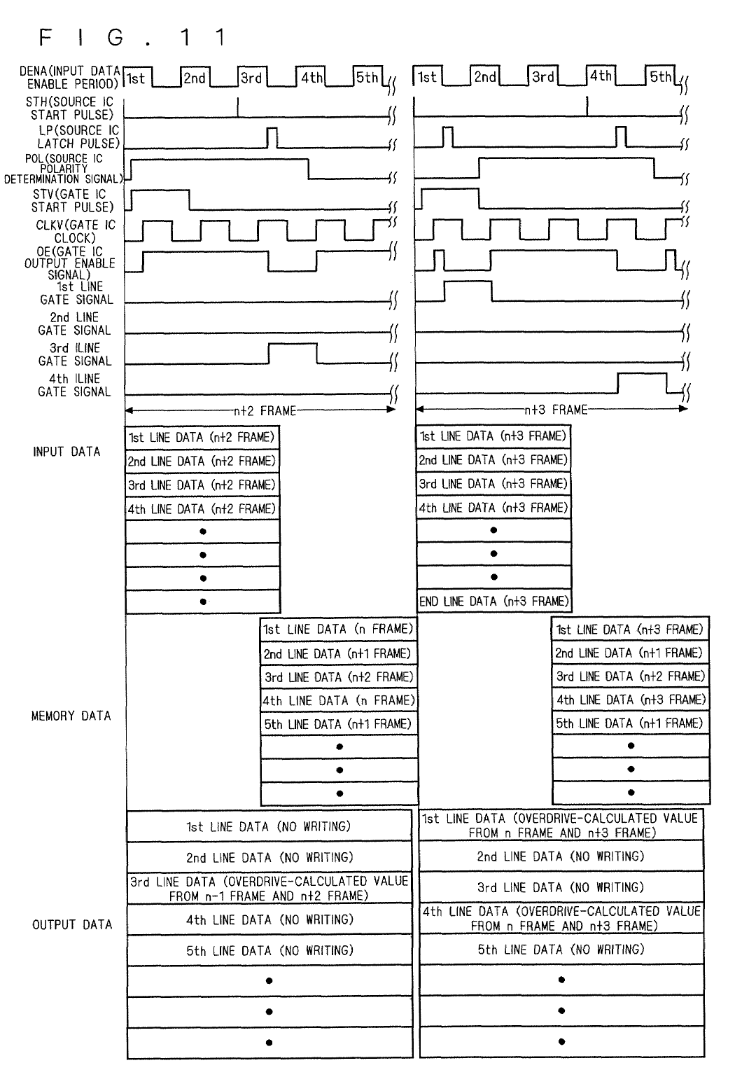

FIG. 10 is a timing chart (n frame and n+1 frame) of a control signal according to a fifth preferred embodiment of the present invention. FIG. 11 is a timing chart (n+2 frame and n+3 frame) of the control signal according to the fifth preferred embodiment. The combination of FIGS. 10 and 11 shows a timing chart of the control signal from the n frame until the n+3 frame. A drive circuit of the liquid crystal display device is identical to that according to the first preferred embodiment.

A characteristic of the fifth preferred embodiment is that the liquid crystal display device is usable at an extremely low temperature without increasing memory capacity, by modifying the structure and the operation method of the first preferred embodiment in a manner that allows overdrive to be performed over three frame periods. The STH and LP are output once every fourth line, and the OE is controlled to match the on period of the gate electrode to that output timing. Only a line for data output is rewritten in the frame memory. The output timing may be set every fifth line, every sixth line, and so forth in a like manner.

As has been described, the data storage circuit has capacity for two frames, and frame data of different frames are stored in odd lines and even lines of each of the one-frame capacities in the fifth preferred embodiment. This allows overdrive to be performed over up to four frame periods, thereby attaining the target gradation at a low temperature. Further, the liquid crystal display device can be used at an extremely low temperature without increasing memory capacity.

### Sixth Preferred Embodiment

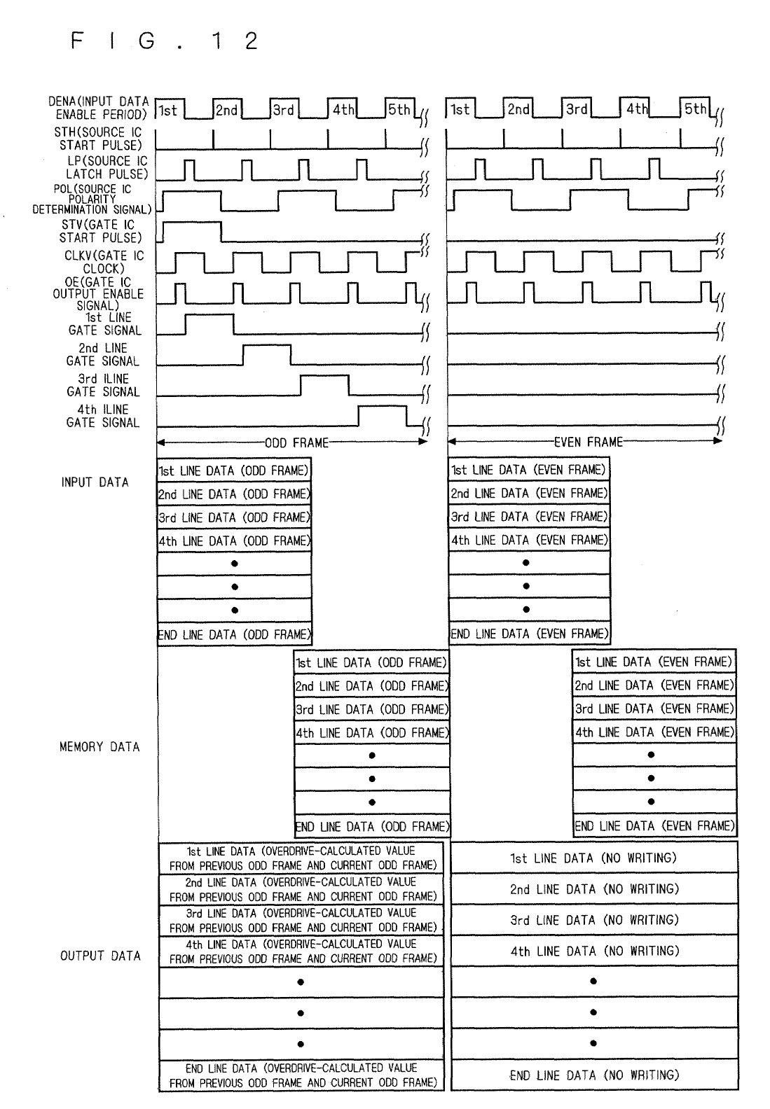

FIG. 12 is a timing chart (ODD frame and EVEN frame) of a control signal according to a sixth preferred embodiment of the present invention. A drive circuit of the liquid crystal display device is identical to that according to the first preferred embodiment.

The difference between the sixth preferred embodiment and the other embodiments is to rewrite data in the data storage circuit (frame memory) 5 and perform output to the liquid crystal panel 1 not by the line but by the frame. When high-speed moving images are displayed on the liquid crystal display devices according to the other embodiments, a displayed image is sometimes reduplicated by ODD lines and EVEN lines and becomes like noise. Such reduplication is prevented in the sixth preferred embodiment by rewriting data in the data storage circuit (frame memory) 5 and performing output to the liquid crystal panel 1 by the frame.

As shown in FIG. 12, the data in the data storage circuit (frame memory) 5 is rewritten only during the ODD frame, to output an overdrive-calculated value calculated from the previous ODD frame data of the second previous frame and input ODD frame data to the liquid crystal panel 1. During the EVEN frame, the data in the data storage circuit (frame memory) 5 is not rewritten, and further the gate electrode is turned off so as not to perform output to the liquid crystal panel 1. Therefore, the previous frame data is held in the frame memory during a frame period over which the data in the data storage circuit (frame memory) 5 is not rewritten, and if overdrive is being performed, the amount of overdrive is held. To turn the gate electrode off during the EVEN frame period, the STV is controlled to be fixed to low. An alternative method of turning the gate electrode off during the EVEN frame period would be to output the STV to fix the OE to high, or output the STV to fix the CLKV to low.

Although a source IC control signal is in operation during the EVEN frame over which the data in the data storage circuit (frame memory) 5 is not rewritten in FIG. 12, all signals including data may be set to low during the EVEN frame in order to reduce power consumption. In addition, to perform overdrive over three or more frame periods, a period during which the data in the data storage circuit (frame memory) 5 is not rewritten and output to the liquid crystal panel 1 is not performed may be increased to two or three frames. In the sixth preferred embodiment, the data in the data storage circuit (frame memory) 5 is rewritten and output to the liquid crystal panel 1 is performed only during the ODD frame period. The effects similar to those of this embodiment can also be obtained by rewriting the data and performing the output only during the EVEN frame period.

As has been described, the data in the data storage circuit (frame memory) 5 is rewritten and output to the liquid crystal panel 1 is performed by the frame, and a period without those operations is provided between a plurality of frames in the sixth preferred embodiment. This allows overdrive to be performed over the plurality of frame periods. By doing so, overdrive can be performed over the plurality of frame periods without increasing memory capacity, and the liquid crystal display device becomes usable at an extremely low temperature. Further, such process performed by the frame prevents the image displayed on the liquid crystal display device from being reduplicated.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display device comprising:
a data storage circuit that stores frame data of the previous image of a liquid crystal panel; and
an overdrive calculation circuit that compares said frame data stored in said data storage circuit and input data of the next image to be displayed on said liquid crystal panel and performs overdrive output to said liquid crystal panel, wherein
said overdrive output is performed over a plurality of frame periods.

2. The liquid crystal display device according to claim 1, wherein said overdrive calculation circuit has the function of performing overdrive over a plurality of frame periods in order to attain target gradation.

3. The liquid crystal display device according to claim 1, capable of performing overdrive over a plurality of frame periods by storing frame data of different frames in areas of said data storage circuit that correspond to odd lines and even lines of said frame data, respectively.

4. The liquid crystal display device according to claim 1, capable of performing overdrive over a plurality of frame periods by storing one of an odd frame and even frame of said frame data in said data storage circuit and holding said one of said frames over said plurality of frame periods.

5. The liquid crystal display device according to claim 1, further comprising:
a temperature detection circuit in the vicinity of said liquid crystal panel that detects a temperature around said liquid crystal panel; and
an overdrive coefficient selection circuit that changes an overdrive coefficient based on a signal received from said temperature detection circuit.

6. The liquid crystal display device according to claim 1, wherein said data storage circuit has capacity for one frame with respect to a plurality of frames.

7. The liquid crystal display device according to claim 1, wherein said data storage circuit has capacity for a plurality of frames with respect to a plurality of frames.
